(19) United States
(12) Patent Application Publication
(10) Pub. No.: US 2009/0262320 A1
(43) Pub. Date: Oct. 22, 2009

(54) Method and Lithographic Apparatus for Acquiring Height Data Relating to a Substrate Surface

(75) Inventors: Frank Staals, Eindhoven (NL); Arthur Winfried Eduardus Minnaert, Veldhoven (NL); Paulus Antonius Andreas Teunissen, Eindhoven (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 12/399,711

(22) Filed: Mar. 6, 2009

Related U.S. Application Data
(60) Provisional application No. 61/064,749, filed on Mar. 25, 2008.

(51) Int. Cl. G03B 27/52

(52) U.S. Cl. 355/55

(57) ABSTRACT

A method of positioning a target portion of a substrate with respect to a focal plane of a projection system uses a level sensor to perform height measurements of at least part of the substrate to generate height data. Specified and/or predetermined correction heights are used to compute corrected height data. The predetermined correction heights may be at least partially based on process stack data. The position of a substrate table is controlled using the correction heights which are partially based on the process stack data, in particular the process stack layer of the target area.

### CROSS-REFERENCE TO RELATED APPLICATIONS

The present application claims the benefit of U.S. Provisional Patent Appl. No. 61/064,749, filed Mar. 25, 2008, which is incorporated by reference herein in its entirety.

### BACKGROUND

1. Field

Embodiments, of the present invention relate to a lithographic apparatus and method for acquiring height data of a substrate surface, to a program and a memory containing the program for acquiring height data and to a method, apparatus, program and memory for correcting height data acquired according to said method. Embodiments of the present invention also relate to a method for positioning a target portion of a substrate with respect to a focal plane of a projection system, a method for generating correction heights to correct height data obtained by a level sensor, as well as a lithographic apparatus, a computer arrangement, a computer program product and a data carrier including such a computer program product for such a method.

2. Background

A lithographic apparatus is a machine that applies a desired pattern onto a target portion of a substrate. Lithographic apparatus can be used, for example, in the manufacture of integrated circuits (ICs). In this case, a patterning device, which is alternatively referred to as a mask or a reticle, may be used to generate a circuit pattern corresponding to an individual layer of the IC. This is done using a projection system that is between the reticle and the substrate and is provided to image an irradiated portion of the reticle onto a target portion of a substrate. The projection system includes components to direct, shape and/or control a beam of radiation. The pattern can be imaged onto the target portion (e.g., including part of one, or several, dies) on a substrate, for example a silicon wafer, that has a layer of radiation-sensitive material, such as resist. In general, a single substrate contains a network of adjacent target portions that are successively exposed. Known lithographic apparatus include so-called steppers, in which each target portion is irradiated by exposing an entire pattern onto the target portion at once, and so-called scanners, in which each target portion is irradiated by scanning the pattern through the projection beam in a given direction, usually referred to as the “scanning” direction, while synchronously scanning the substrate parallel or anti-parallel to this direction.

The lithographic apparatus may be of a type having two (dual stage) or more substrate tables (and/or two or more mask tables). This is described in more detail below.

In current dual stage apparatus, data is gathered to level every target portion (field) with a level sensor in exactly the same position with respect to the center of the target portion. A level sensor is explained in more detail below.

The projection system includes components to direct, shape and/or control a beam of radiation. The pattern can be imaged onto the target portion (e.g., including part of one, or several, dies) on a substrate, for example a silicon wafer, that has a layer of radiation-sensitive material, such as resist. In general, a single substrate contains a network of adjacent target portions that are successively exposed. Known lithographic apparatus include so-called steppers, in which each target portion is irradiated by exposing an entire pattern onto the target portion at once, and so-called scanners, in which each target portion is irradiated by scanning the pattern through the projection beam in a given direction, usually referred to as the “scanning” direction, while synchronously scanning the substrate parallel or anti-parallel to this direction.

For the sake of simplicity, the projection system may hereinafter be referred to as the “lens”; however, this term should be broadly interpreted as encompassing various types of projection system, including refractive optics, reflective optics, catadioptric systems, and charged particle optics, for example. The radiation system may also include elements operating according to any of these principles for directing, shaping or controlling the projection beam, and such elements may also be referred to below, collectively or singularly, as a “lens”. In addition, the first and second object tables may be referred to as the “mask table” and the “substrate table”, respectively.

A lithographic apparatus can contain a single mask table and a single substrate table, but is also available having at least two independently moveable substrate tables; see, for example, the multi-stage apparatus described in International Patent Applications WO98/28665 and WO98/40791, incorporated herein by reference in their entireties. The basic operating principle behind such multi-stage apparatus is that, while a first substrate table is at the exposure position underneath the projection system for exposure of a first substrate located on that table, a second substrate table can run to a loading position, discharge a previously exposed substrate, pick up a new substrate, perform some initial measurements on the new substrate and then stand ready to transfer the new substrate to the exposure position underneath the projection system as soon as exposure of the first substrate is completed; the cycle then repeats. In this manner it is possible to increase substantially the machine throughput, which in turn improves the cost of ownership of the machine. It should be understood that the same principle may be used with just one substrate table which is moved between exposure and measurement positions.

During exposure processes, it is important to ensure that the mask image is correctly focused on the wafer. Conventionally this has been done by measuring the vertical position of the best focal plane of the aerial image of the mask relative to the projection lens before an exposure or a series of exposures. During each exposure, the vertical position of the upper surface of the wafer relative to the projection lens is measured and the position of the wafer table is adjusted so that the wafer surface lies in the best focal plane.

Referring to FIG. 1, the scope for adjusting the position of the focal plane of the projection system PL is limited and the depth of focus of that system is small. This means that the exposure area of the wafer (substrate) must be positioned precisely in the focal plane of the projection system PL.

Wafers are polished to a very high degree of flatness but nevertheless deviation of the wafer surface from perfect flatness (referred to as “unflatness”) of sufficient magnitude noticeably to affect focus accuracy can occur. Unflatness may be caused, for example, by variations in wafer thickness, distortion of the shape of the wafer or contaminants on the wafer holder. The presence of structures due to previous process steps also significantly affects the wafer height (flatness). In embodiments of the present invention, the cause of unflatness is largely irrelevant; only the height of the top surface of the wafer is considered. Unless the context otherwise requires, references below to “the wafer surface” refer to the top surface of the wafer onto which will be projected the mask image.

During exposures, the position and orientation of the wafer surface relative to the projection optics are measured and the vertical position (Z) and horizontal tilts (Rx, Ry) of the wafer table WT are adjusted to keep the wafer surface at the optimal focus position.

As described above, imaging a pattern onto a substrate W is usually done with optical elements, such as lenses or mirrors. In order to generate a sharp image, a layer of resist on the substrate W should be in or near the focal plane of the optical elements.

Therefore, according to the prior art, the height of the target portion C that is to be exposed is measured. Based on these measurements, the height of the substrate W with respect to the optical elements is adjusted, e.g., by moving the substrate table WT on which the substrate W is positioned. Since a substrate W is not a perfectly flat object, it may not be possible to position the layer of resist exactly in the focal plane of the optics for the whole target portion C, so the substrate W may only be positioned as well as possible.

In order to position the substrate W in the focal plane as well as possible (e.g., by matching the focal plane to the centre of the resist thickness), the orientation of the substrate W can be altered. The substrate table WT may be translated, rotated or tilted, in all six degrees of freedom, in order to position the layer of resist in the focal plane as well as possible.

In order to determine the best positioning of the substrate W with respect to the optical elements, the surface of the substrate W may be measured using a level sensor, as for instance described in U.S. Pat. No. 5,191,200, incorporated herein by reference in its entirety. This procedure may be done during exposure (on-the-fly), by measuring the part of the substrate W that is being exposed or is next to be exposed, but the surface of the substrate W may also be measured in advance. This latter approach may also be done at a remote position. In the latter case, the results of the level sensor measurements may be stored in the form of a so-called height map or height profile and used during exposure to position the substrate W with respect to the focal plane of the optical elements.

In both cases, the top surface of the substrate W may be measured with a level sensor that determines the height of a certain area. This area may have a width about equal to or greater than the width of the target portion C and may have a length that is only part of the length of target portion C, which will be explained below (the area being indicated with the dashed line). The height map of a target portion C may be measured by scanning the target portion C in the direction of the arrow A.

An air gauge, as will be known to a person skilled in the art, determines the height of a substrate W by supplying a gas flow from a gas outlet to the surface of the substrate W. Where the surface of the substrate W is high, i.e., the surface of the substrate W is relatively close to the gas outlet, the gas flow will experience a relatively high resistance. By measuring the resistance of the flow as a function of the spatial position of the air gauge above the substrate W, a height map of the substrate W can be obtained. A further discussion of air gauges may be found in EP0380967, incorporated hereing by reference in its entirety. The air gauge (AG) is a pneumatic calibration sensor for the level sensor.

According to an alternative, a scanning needle profiler is used to determine a height map of the substrate W. Such a scanning needle profiler scans the height map of the substrate W with a needle, which also provides height information.

In fact, all types of sensors may be used that are arranged to perform height measurements of a substrate W, to generate height data.

A level sensing method uses at least one sensing area and measures the average height of a small area, referred to as a level sensor spot LSS. The level sensor may simultaneously apply a number of measurement beams of radiation, creating a number of level sensor spots LSS on the surface of the substrate W.

The level sensor determines the height of the substrate W by applying a multi-spot measurement, such as for instance a 9-spot measurement. Level sensor spots LSS are spread over the area and, based on the measurements obtained from the different level sensor spots, height data may be collected.

The term “height” as used here refers to a direction substantially perpendicular to the surface of the substrate W, i.e., substantially perpendicular to the surface of the substrate W that is to be exposed. The measurements of a level sensor result in height data, including information about the relative heights of specific positions of the substrate W. This may also be referred to as a height map.

In the most common case of a columnar target portion layout, obtaining height data relating to the complete substrate surface will use a ‘stroke’ of level sensor readings through each column. This is further illustrated with reference to FIG. 2 showing a substrate W with a plurality of fields 40 and arrows indicating the scanning path or strokes of the level sensor.

Based on this height data, a height profile may be computed, for instance by averaging corresponding height data from different parts of the substrate (e.g., height data corresponding to similar relative positions within different target portions C). In case such corresponding height data is not available, the height profile is equated to the height data.

Based on height data or a height profile, a leveling profile may be determined to provide an indication of an optimal positioning of the substrate W with respect to a projection system PS. Such a leveling profile may be determined by applying a linear fit through (part of) the height data or the height profile, e.g., by performing a least squares fit (three dimensional) through the points that are inside the measured area.

As explained above, accurate leveling may require measuring the shape and topography of the substrate, for instance using a level sensor, resulting in height data of (at least part) of the substrate W, based on which a leveling profile can be determined. Such a leveling profile may represent the optimal position of the substrate W with respect to the projection system PS, taking into account the local shape and height of the substrate W.

Some level sensors are process dependent. Although the height data acquired from the level sensor might be expected to indicate the top of the substrate, the attained value could indicate a value not corresponding with the actual height. The value can be above of below the actual value. For a field C of a substrate the magnitude of the error can be in the order of tens of nanometers. Effects causing the difference between measured (apparent) height and actual height can have different backgrounds. One known effect is apparent surface depression ASD, due to wavefront tilt. Another effect is indicated in detail in FIG. 4.

FIG. 4 shows schematically a cross sectional view of a substrate surface. The cross sectional view is taken along the y-axis or scanning direction according to the stroke as depicted in FIG. 2. Incident radiation 100 from a schematically depicted radiation source 101 of a level sensor is projected on the substrate W surface having a “stepped” surface structure. This surface structure was formed in previous steps of manufacturing by imaging layer after layer on the substrate. The layers are formed corresponding to layer stack data, corresponding to forming the layers of the end product having a certain topology. The last layer is imaged at a top layer according to the process layer data. The term “process layer data” shall refer in this application to data used for forming at least the last layer on the substrate, being part of the substrate surface. The process layer data can include data of earlier/older layers that have been covered subsequently.

The term substrate surface shall refer to at least the top substrate layer, but can include subsequent lower/older layers.

At the left hand side an incoming beam 100 is partially reflected by the immediate top layer 102. In the example about 50% of the incoming radiation is reflected. The amount of height reading error is dependent on absorption, indices of refraction, etc., of the material of the top layer. About 20% of the incident radiation is reflected by a lower layer and 30% by an even older layer. The process dependency is therefore also dependent on one or more of the most recent layers.

A further incident beam 104 is depicted at the right hand side of FIG. 4. About 20% is reflected by a layer 105, about 40% is reflected by a layer 106 and 40% by another part of the substrate surface. A level sensor detecting the reflected radiation will not be able to compute the position of the top layer without further information.

FIG. 4 further indicates with the dashed line 120 the desired height of the focal plane of the projection system of a lithographic apparatus when illuminating the substrate/resist for manufacturing a device on the substrate W. The desired height 120 is an average height of the substrate surface at the target area.

Without taking into account the process dependency, it will not be possible to provide an approximate value for the desired height 120 from the reflected radiation. The actual height reading error (resulting in an apparent height different from the actual height) is further dependent on the level sensor light spectrum, polarization and hardware properties.

An air gauge calibration as a correction for data obtained with a radiation height reading error level sensor such as the level sensor demonstrated in FIG. 4, is a lengthy measurement. It is desired to perform the calibration more quickly. A calibration, such as an AG calibration further suffers from drift.

### SUMMARY

It is an aspect of the present invention to alleviate, at least partially, the problems discussed above by providing a method for positioning at least one target portion of a substrate with respect to a focal plane of a projection system, the method including in an embodiment: performing height measurements of at least part of the substrate to generate height data; using predetermined correction heights to compute corrected height data; and positioning the target portion of the substrate with respect to the focal plane of the projection system at least partially based on the corrected height data, wherein the method further includes inputting process stack data, wherein the predetermined correction heights are calculated correction heights at least partially based on the process stack data.

Calculating the predetermined correction heights may include defining a grid having grid portions, calculating height reading errors for each grid portion and averaging the calculated difference of each grid portion over the target area.

Calculating the LS reading error may include calculating the difference of the apparent height of a layer stack on a substrate and the actual top layer based on the process stack data. The height measurements may be performed by scanning the at least part of the substrate in a scanning direction with a level sensor.

According to a further aspect a method of manufacturing a device is provided using a lithographic projection apparatus including: a radiation system for supplying a projection beam of radiation; a first object table provided with a mask holder for holding a mask; a second object table provided with a substrate holder for holding a substrate; a level sensor for measuring at least one of the vertical position and tilt about at least one horizontal axis of an object held by one of said object holders, and generating a position signal; a servo system responsive to said position signal for moving said object to a desired position; the method including the steps of providing a mask bearing a pattern to said first object table; providing a substrate having a radiation-sensitive layer to said second object table; and imaging said irradiated portions of the mask onto said target portions of the substrate by operating said servo system to maintain said object at said desired position; wherein the desired position is based at least partially on correction height data calculated at least partially based on process stack data.

Calculating the predetermined correction heights may include defining a grid having grid portions, calculating LS height reading errors for each grid portion, and averaging the calculated difference of each grid portion over the target area. In an embodiment the method further includes calculating the LS height reading errors by calculating the difference of the apparent height of a layer stack in a height measurement and the actual top layer, said calculation being partially based on the process stack data.

According to a further aspect a lithographic projection apparatus is provided, the apparatus including: a support constructed to support a patterning device, the patterning device being capable of imparting a radiation beam with a pattern in its cross-section to form a patterned radiation beam; a substrate table arranged and constructed to hold a substrate; a projection system arranged and constructed to project the patterned radiation beam onto a target portion of the substrate; a level sensor arranged and constructed to perform height measurements of at least part of the substrate to generate height data, for use in positioning a target portion of the substrate with respect to a focal plane of the projection system; an actuator for positioning the substrate table with respect to the projection system; a controller arranged and constructed to control the actuator to position the target portion of the substrate in the focal plane of the projection system in accordance to corrected height measurements, wherein the controller includes a processor for correcting the height measurements with a predetermined correction height from memory, wherein the memory contains correction heights based at least partially on process stack data.

In an embodiment the memory contains instructions representing process stack data and the processor is arranged and constructed to calculate the predetermined correction heights at least partially based on the process stack data in the memory.

The memory can further contain instructions representing reflective properties of substrate materials, and the processor is arranged and constructed to calculate the predetermined correction heights at least partially based on the reflective properties of substrate materials in the memory.

According to yet another aspect a system for controlling the position of a substrate is provided, the system including a processor and a memory, the memory being encoded with a computer program containing instructions that are executable by the processor to perform, using height data, a method for positioning a target portion of the substrate with respect to a focal plane of a projection system, wherein the method includes: performing height measurements of at least part of the substrate to generate the height data; using predetermined correction heights to compute corrected height data for the height data; and positioning the target portion of the substrate with respect to the focal plane of the projection system at least partially based on the corrected height data, wherein the predetermined correction heights are calculated at least partially based on process stack data.

The system may be adapted to process height measurements from a level sensor.

According to yet a further aspect a computer-readable medium is provided, the medium encoded with a computer program containing instructions that are executable by a processor to perform, using height data, a method for positioning a target portion of a substrate with respect to a focal plane of a projection system, wherein the method includes: performing height measurements of at least part of the substrate to generate the height data; using predetermined correction heights to compute corrected height data for the height data; and positioning the target portion of the substrate with respect to the focal plane of the projection system at least partially based on the corrected height data, wherein the predetermined correction heights are calculated at least partially based on process stack data.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 schematically depicts an exemplary lithographic apparatus.

FIG. 2 schematically depicts a substrate with a plurality of target portions and arrows indicating the scanning path of the level sensor according to the prior art.

FIG. 3 is a more detailed view of parts of the apparatus of FIG. 1, according to an embodiment of the invention.

FIG. 4 schematically depicts a substrate with a plurality of target portions and arrows indicating the scanning path of the level sensor according to the prior art.

FIG. 5 schematically depicts height data for a wafer according to an embodiment of the invention.

FIG. 6 schematically depicts a controller for a lithographic apparatus according to an embodiment of the invention.

FIG. 7 schematically depicts a method of determining corrected height data according to an embodiment of the invention.

FIG. 8 schematically depicts a target portion.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

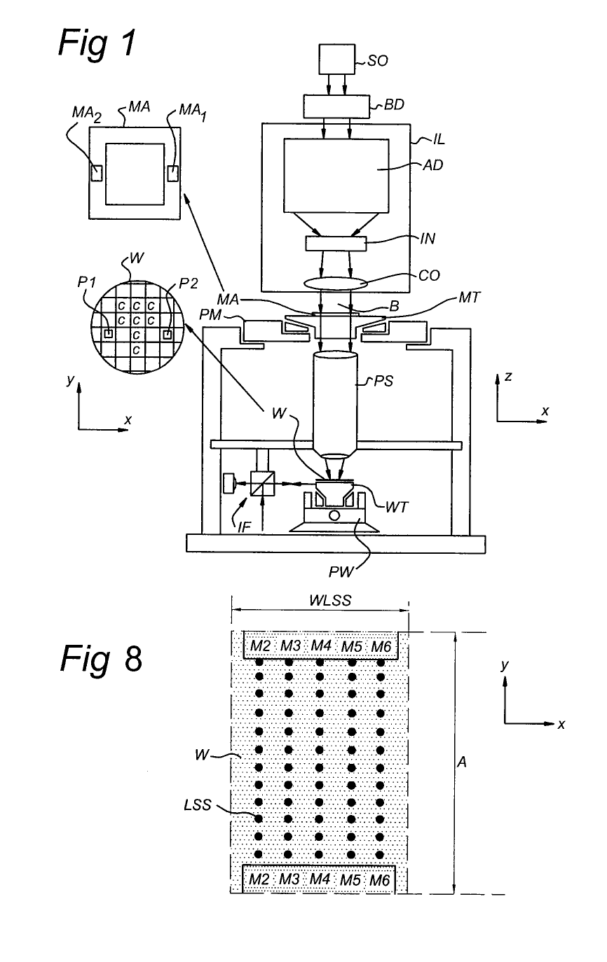

FIG. 1 schematically depicts a lithographic apparatus according to one embodiment of the invention. The apparatus includes:
an illumination system (illuminator) IL arranged and constructed to condition a radiation beam B (e.g., UV radiation or EUV radiation).
a support structure (e.g., a mask table) MT constructed to support a patterning device (e.g., a mask) MA and connected to a first positioner PM arranged and constructed to accurately position the patterning device in accordance with certain parameters;
a substrate table (e.g., a wafer table) WT constructed to hold a substrate (e.g., a resist-coated wafer) W and connected to a second positioner PW arranged and constructed to accurately position the substrate in accordance with certain parameters; and
a projection system (e.g., a refractive projection lens system) PS arranged and constructed to project a pattern imparted to the radiation beam B by patterning device MA onto a target portion C (e.g., including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g., so as to position different target portions C in the path of the radiation beam B. Similarly, the first positioner PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks MA1, MA2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure target portion limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PS. In scan mode, the maximum size of the exposure target portion limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

### Level Sensor

A level sensor measures heights of substrates W or of areas on the substrate table WT to generate height data. A surface, of which the height is to be measured, is brought in a reference position and is illuminated with a measurement beam of radiation. The measurement beam of radiation impinges on the surface to be measured under an angle which is less than 90°. Because the angle of incidence is equal to the angle of height reading error, the measurement beam of radiation is reflected back from the surface with the same angle to form a reflected beam of radiation. The measurement beam of radiation and the reflected beam of radiation define a measurement plane. The level sensor measures the position of the reflected beam of radiation in the measurement plane.

If the surface is moved in the direction of the measurement beam of radiation and another measurement is done, the reflected beam of radiation is reflected in the same direction as before. However, the position of the reflected beam of radiation has shifted the same way the surface has been moved.

The level sensor is arranged to perform a level sensor scan over the target portion providing level sensor data for the target portion.

The embodiments described here may of course also be used for other types of level sensors, such as air gauges. An air gauge, as will be known to a person skilled in the art, determines the height of a substrate W by supplying a gas flow from a gas outlet to the surface of the substrate W. Where the surface of the substrate W is high, i.e., the surface of the substrate W is relatively close to the gas outlet, the gas flow will experience a relatively high resistance. By measuring the resistance of the flow as a function of the spatial position of the air gauge above the substrate W, a height map of the substrate W can be obtained. A further discussion of air gauges may be found in EP0380967, incorporated herein by reference in its entirety.

According to an alternative, a scanning needle profiler is used to determine a height map of the substrate W. Such a scanning needle profiler scans the height map of the substrate W with a needle, which also provides height information.

In fact, all types of sensors may be used that are arranged to perform height measurements of a substrate W, to generate height data.

The level sensing method uses at least one sensing area referred to as a level sensor spot LSS. The method intends to measure the average height of that area. In an embodiment five, seven or nine spots are used collectively.

According to an embodiment, the level sensor may simultaneously apply a number of measurement beams of radiation, creating a number of level sensor spots LSS on the surface of the substrate W. As shown in FIG. 8, the level sensor may for instance create five level sensor spots LSS in a row. The level sensor spots LSS scan the area of the substrate W to be measured (for instance target portion C), by moving the substrate W and the level sensor relatively with respect to each other, indicated with arrow A (scanning direction).

Depending on the position of the level sensor spot LSS on the substrate W, a selection mechanism selects the level sensor spot or spots LSS, which are applicable to derive height data from a measured target area C. Based on the selected level sensors spots LSS, a level profile may be computed.

The depicted apparatus can be used in various modes. For example, in step mode, the mask table MT and the substrate table WT are kept essentially stationary, while an entire pattern imparted to the projection beam is projected onto a target portion C at once (i.e., a single static exposure). The substrate table WT is then shifted in the X and/or Y direction so that a different target portion C can be exposed. In step mode, the maximum size of the exposure field limits the size of the target portion C imaged in a single static exposure.

In FIG. 3, a part of the measurement station region of the lithographic apparatus is shown. The substrate W is held on the substrate table WT. Two wafer stage chucks WT are visible in FIG. 3. The left hand side is the substrate table in the expose position I and the right hand side is the substrate table WT in the measure position II.

In order to determine an absolute mirror map, the x-position of the wafer table WT is monitored using the interferometers IF and a plurality of level sensor LS measurements is performed at various different x-positions across the wafer. Each level sensor measurement may optionally be static. In this case, typically each level sensor would take a number of measurements at each measurement point and provide an average value, thereby to reduce the effects of noise. In a typical example, each level sensor may take six hundred readings at a single point, although different sensors may be arranged and constructed to take different numbers of readings and indeed different numbers of readings may be taken at different positions of the substrate table. As will be appreciated, whilst increasing the number of measurements reduces the effects of noise, it also increases the measurement time. Hence, there is a trade off between calibration time and measurement accuracy. As an alternative to a static measurement, the wafer table WT may be moved along the direction of the level sensor array LS, whilst the level sensor array LS is taking measurements. Measurements relating to specific points of the wafer may be obtained by sampling the sensor outputs at appropriate times. In this case, the number of measurements that are taken at each point will typically be lower than for the static measurement, and may be only one.

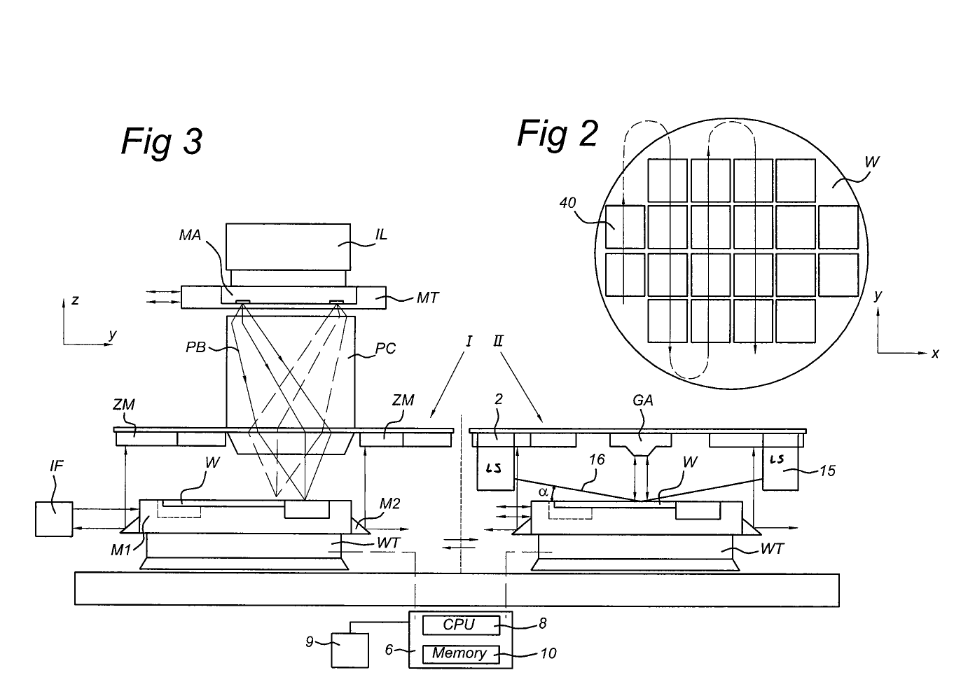

The processor 8 further receives information from position sensors 25 measuring the actual position of the substrate table WT or substrate table holder by electric (capacitive, inductive) or optical, e.g., interferometric devices. FIGS. 1 and 2 show examples of direction definitions X, Y, Z. Z is usually used to indicate a height direction, as shown in FIG. 1 right hand side. The substrate W is positioned in the X-Y plane as indicated in FIG. 2. Scanning of the surface according to FIG. 2 is executed by performing long strokes in the Y direction over the middle part of fields 40 on the substrate W.

FIG. 3 shows a system for determining the position of a wafer on the wafer/substrate table WT or “chuck” as it is sometime referred to in the art. This includes two interferometers IF, one on each of opposite sides of the substrate table WT. Each interferometer IF is positioned to direct measurement radiation onto one of a first pair of mirrors M1 that are provided on opposing sidewalls of the table, these mirrors M1 being substantially perpendicular to the radiation emitted from the associated interferometer IF. These will be referred to as the X-mirrors M1. In addition, each interferometer IF is positioned to direct measurement radiation onto one of a second pair of mirrors M2 that are angled at 45 degrees to the direction of propagation of radiation from the interferometer IF. These mirrors M2 are provided on opposing sidewalls of the table WT. These will be referred to as the angled mirrors M2.

The X-mirrors M1 and the angled mirrors M2 are carried on the wafer table WT and so move when the table WT is moved. Radiation reflected from each X-mirror M1 is directed back to its associated interferometer IF and can be used to determine the x-position of the wafer table WT. Radiation reflected from the angled mirrors M2 is directed onto one of a pair of Z-mirrors ZM positioned above the level of the wafer table WT and then subsequently reflected back to the interferometer IF. The dots that are shown on the Z-mirrors ZM of FIG. 3 are indicative of the positions where the interferometer IF beams reside during measurements. By using radiation reflected from each Z-mirror ZM in combination with a measure of the x-position determined using the X-mirrors M1, it is possible to obtain an indirect measure of the height of the Z-mirror ZM and so the wafer table WT.

The processor 8 also receives input from a level sensor LS which measures the height and/or tilt information from the target area C on the substrate W where the projection beam PB hits the substrate surface. The control device 6 may be connected to a reporting system 9, which may include a PC or a printer or any other registration or display device.

The level sensor LS may be, for example, an optical sensor as described here; alternatively, a pneumatic or capacitive sensor (for example) is conceivable. In FIG. 3 also an air gauge GA is shown in the measure position.

A level sensor is provided to determine a level parameter of the substrate W to enable a controller 6 to position the substrate surface in the focal plane of the projection system PS. The level sensor may include a level difference sensor constructed to measure a level difference between the surface of the substrate and the surface of the surrounding structure and the level parameter includes the level difference. An advantage of this arrangement is that measurement of the level difference can be performed as a single action, thus obviating a need to measure the level of the substrate and the surrounding structure separately. Further, the level difference may be measured with existing level sensors used for focus control during exposure of the substrate.

In another embodiment, the level sensor includes a level measurement sensor constructed to measure a level of the surface of the substrate when held by the substrate table and the level parameter includes the level of the surface of the substrate. In this case, the controller is further provided with a level of the surrounding structure to position the substrate table with respect to the surrounding structure. An advantage of this configuration is that this provides for a simple solution, advantageous in an embodiment wherein only the substrate table is moved by the actuators and the surrounding structure is stationary.

The level sensor LS may measure the vertical position of one or more very small areas (level sensor spots LSS) of about 1-10 mm², e.g., 5 mm² (e.g., 2.8×2.5 mm) of the substrate W to generate height data. The level sensor LS shown in FIG. 3 includes a radiation source for producing a radiation beam 16, projection optics (not shown) for projecting the light beam 16 onto the substrate W, detection optics (not shown) and a sensor or detector. The level sensor includes a projection part 2 and a detection part 15.

The LSS will define a LSS grid. The LSS grid is a discrete set of areas, wherein for each area a height measurement is performed. The height measurements can be collected and/or stored according to the grid positions. An example LSS grid is shown in FIG. 8.

The detection part 15 generates a height-dependent signal, which is fed to the processor 8. The processor 8 is arranged to process the height information and to construct a measured height map. The measured height map has a resolution corresponding to the LSS-grid. Such a height map may be stored by the processor 8 in the memory 10 and may be used during exposure.

According to an alternative, the level sensor 2, 15 may be an optical sensor making use of Moiré patterns formed between the image of a projection grating reflected by the substrate surface and a fixed detection grating, as described in U.S. Pat. No. 5,191,200, incorporated herein by reference in its entirety. It may be desirable for the level sensor 15 to measure the vertical height of a plurality of positions simultaneously and/or to measure the average height of a small area for each position.

Actuators (not shown in the drawings) are arranged to generate a relative movement of the substrate table WT with respect to level sensor fixed to the lithographic apparatus. Scanning according to FIG. 2 will have a (maximum) scanning speed in the Y direction limited by the capabilities of the actuators.

The controller 6, which is connected to the actuators, is arranged and constructed to control operation of the actuators. The controller 6 is also provided with an output signal from a level sensor.

The controller 6 can include any type of controller such as an electronic controller, analog, digital, or a combination thereof, including, e.g., a microprocessor, microcontroller, other type of programming device, application specific integrated circuitry, or any other type of programmable device. The actuator can be connected to the controller via any suitable connection, such as an analogue line, a digital line, a multiplexed digital line, or any other communication channel.

FIG. 2 shows schematically an example of strokes performed during scanning of the fields 40 on the substrate W. Strokes are scanned over the centre of the fields generally in the Y-direction. Other examples for scanning are possible within embodiments of the invention. The invention is not limited to the example of FIG. 2. In an embodiment a layout-independent scanning, not taking the layout of fields 40 on the substrate into account, is considered.

Further actuators allow movement of the substrate in the Z-direction as well as rotation around any of the three axes. Tilt actuators allow tilting of the substrate around Rx, Ry and Rz. Tilting around Rx and Ry, as well as relative positioning in the Z-direction are relevant for positioning the substrate surface W in the focal plane of the projection system PS. The relative positioning is controlled by controller 6 in accordance to values or data calculated by processor 8 using values from memory 10. The desired position of the substrate table WT as used in this application is a position of the substrate table when holding the substrate, such that the substrate surface is in the focal plane of the projection system.

A level sensor is process dependent. Instead of an indication of the top surface of the substrate, the level sensor reads a value either above or below the intended value. The magnitude of error variation is tens of nm over a field, being defined as a target area on the substrate. This offset depends on the process layers present/manufactured on the wafer. If measured height data are available, these data should be corrected using a field offset map. In embodiments of the present invention, such a field offset map is provided more quickly that was previously available.

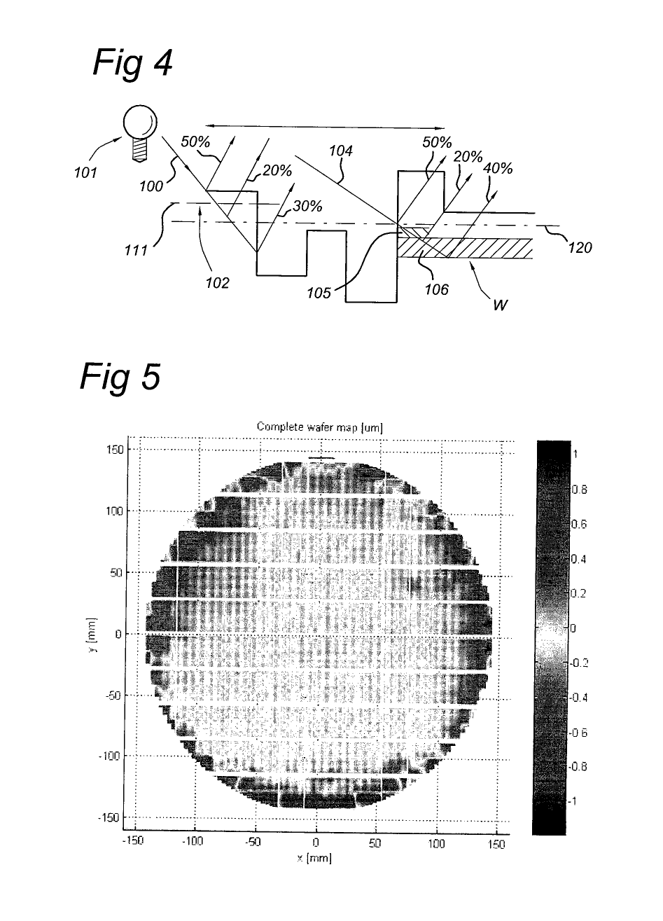

The process dependency of an example substrate is depicted in FIG. 4 and discussed hereabove.

According to an embodiment of the invention, a correction of level sensor data obtained e.g., according to a method as depicted in FIG. 4, is provided. The measured height data are corrected using correction height data. The correction height data are obtained according to an embodiment of the invention by calculation instead of e.g., a subsequent measurement using e.g., an air gauge (AG). Since according to an embodiment of the invention a subsequent calibration or correction measurement is superfluous, an important amount of time can be saved, resulting in costs savings.

FIG. 5 depicts an example graph of a wafer map. The wafer map is obtained by calculation using a processor 8 in a controller 6 connected to a level sensor 2, 15, receiving measurement data from the level sensor. The wafer map according to FIG. 5 shows a relative bending of the substrate W on the wafer table WT having upwardly bended edges.

Such a wafer map allows the controller to calculate a leveling profile as a subsequent step, wherein the leveling profile corresponds with a relative position of the substrate table WT holding the substrate W with respect to the focal plane of the projection system PS during one of the operation modes. Using the wafer map according to FIG. 5, the substrate table WT is moved and positioned under the control of a controller 6 to a desired position, wherein the substrate W is positioned in the focal plane of the projection system. The skilled person will be able to perform such positioning using and based on a wafer map similar to FIG. 5. The actuator for positioning the substrate table WT as well as actuators for tilting the substrate table WT can be used in combination and can be used in any of the operation modes of the lithographic apparatus.

In an embodiment the level sensor 2, 15 scans the substrate surface and detects height data. The height data can be processed in order to obtain a non-corrected wafer map, containing data influenced by the normal process dependencies as illustrated above. Such a non-corrected wafer map could be displayed in a similar fashion as FIG. 5.

Correction height data can be obtained by calculation using process stack data. Process stack data according to an embodiment of this invention is data relating to the current or latest formed layers of the substrate for which a level measurement is performed. The process stack data according to an embodiment of the invention is therefore dependent on the exact step in the process of manufacturing a device on the substrate. The process stack data includes information with respect to the latest formed layer on the substrate W. The process stack data at one step of the method of manufacturing the device on a lithographic apparatus according to an embodiment of the invention therefore does not necessarily include information with respect to all layers (formed or to be formed) in the device/on the substrate.

The process stack data includes, according to an embodiment, data with respect to the position of and thickness of formed layers on or near the substrate surface, e.g., the layer thickness of layers 105, 106 in FIG. 4. The process stack data allows simulation software calculations in order to calculate effects as shown in FIG. 4.

Simulation software is known in the art. According to an embodiment of the invention a program is provided to calculate a field offset map to be on the uncorrected wafer map height measurements generated and measured with the level sensor. The field offset map can be applied on the height measurement map in order to obtain a corrected height wafer map, which can be used to position the substrate in the focal plane of the projection system.

The field offset map can be calculated using at least the process stack data with e.g., a processor 8 present on the lithographic apparatus. The field offset map can however also be provided externally from the lithographic apparatus.

In an embodiment the field offset map is calculated with a processor 8 based at least partially on the properties of materials used in and on the substrate. The relevant material properties include but are not limited to indices of refraction, absorption, and polarization. The relevant material properties can be provided as a data table, for example, as electronic data available in a memory such as the memory 10. The relevant material properties can be included in instructions stored on a recordable or programmable medium according to an embodiment of the invention. In an embodiment the data of relevant material properties is accessible through a network at a storage connected to the network. The network can be the Internet. The relevant material properties, or at least part of the data, can be temporarily stored in the memory 10.

The instructions of a program according to an embodiment of the invention are capable of generating a field offset map calculated using process stack data in accordance with an embodiment of the invention in order to correct the data measured with a level sensor for process dependencies.

In a further embodiment it is possible to calculate the level sensor gain error map for process dependent gain correction. Either average level sensor parameters or machine specific level sensor parameters can be used for this. The LS gain curve may have a sine-like form. The second method for gain correction includes the interaction of the LS grating with grating like patterns on the substrate. The level sensor parameters can be stored in a memory, connected to or accessible from a processor 8 on the lithographic apparatus. In another embodiment the level sensor gain map can be generated externally through calculation according to the invention, and the calculated instructions are provided to the lithographic apparatus in order to process the gain error map.

The level sensor can be a level sensor having level sensor spots LSS. In an example, the spots have a specified size of about 1-4 mm (X)×about 1-5 mm (Y), such as 2.5 mm×2.8 mm. The measurement pitch in the X-direction may be about 1-6 mm, for example 3.4 mm, and in the Y-direction about 0.1-4 mm, for example 0.5 mm. The specified size results in the discrete or “blocked” wafer map according to FIG. 5. An embodiment of the invention includes calculating the field offset map having a corresponding sampled (discrete or blocked) set up, for example, having the same scale or grid.

In accordance with an embodiment of the invention, a method of calculating the field offset map includes creating a grid having grid portions. This is indicated in FIG. 7 as step 160. Step 160 includes setting up a grid of small grid portions, e.g., areas of about 50 nm×50 nm. The process stack data can be made correspondingly discrete. For each grid portion at least the height, layer thickness(es) and substance of material may be known. In an embodiment grid portions can correspond to larger areas such as 100 nm×100 nm or even larger.

In a further step 161, the method further includes calculating the height reading error equal to the difference between apparent height and actual height, using the height reading error for each grid portion at least partially based on the process stack data supplied from a memory 162. The process stack data provide information with respect to the structure of the formed substrate for which a height measurement is performed and should be corrected. The process stack data provide a processor with information with respect to the stacked layers at the respective grid portion. For each of the grid portions the processor is able, using a suitable algorithm, to calculate the height difference/height reading error, using material properties also available from a memory 162. For each mini grid area of 50×50 nm the height error is calculated. A maxigrid can be defined e.g., including 50.000̂2 mini grid areas and an average height error can be calculated for the maxigrid using the height errors of the mini grid areas. Each maxi grid area can correspond to generally a macro-scale LSS.

In an embodiment, calculating the height error for a grid portion includes calculating the effect of surrounding grid portions. This may be done, for example, for top layers and boundaries of such layers in the top surface. As the top layer of the substrate extends from subsequent lower layers, a boundary effect at the transition from lower layer to top layer may have influence on the reflectivity.

From the memory 163 the exact position of the top layer of the substrate is available. The memory 163 may be the same memory 162. The position of the top layer is known from the process stack data. The top layer positions/locations can be made discrete in a similar fashion for the grid as defined in step 160. This allows obtaining data with respect to the top position of the layer for each grid portion.

Combining the top position of the layer with the calculated height reading error according to step 161 at step 164 allows obtaining a data set containing the local level sensor error. In step 164 the field offset map is available.

In fact locally this field offset map corresponds with the difference in height schematically indicated in FIG. 4 between the top of the substrate at the left hand side and the level sensor measured height using the height reading error, which is the measured height based on or deducted from the combined height reading error of the 50%, 20% and 30% height reading error of the different subsequent layers. The measured height is somewhat lower than the top level height.

At step 164 a very detailed map, having the small grid created at step 160, is available for correcting the errors in level sensor measurement data. In a step 165 this data is averaged. The data of each grid portion is used to calculate by averaging an LS measurement error to obtain a field offset map at generally the same scale as the wafer map data obtained using the LS measurement. The wafer map according to FIG. 5 has a grid of e.g., 2 mm×2 mm. The skilled person will be able to provide an algorithm for averaging out the smaller grid as defined in step 160 into the larger grid of the wafer map.

The results from step 165 form the predetermined correction data for level sensor error correction. The predetermined correction data can be used by a processor 8 to determine the corrected height data.

In a further embodiment, the method includes the step of calculating the desired position 120 as indicated in FIG. 4 for a target portion of the substrate W in order to create a height profile.

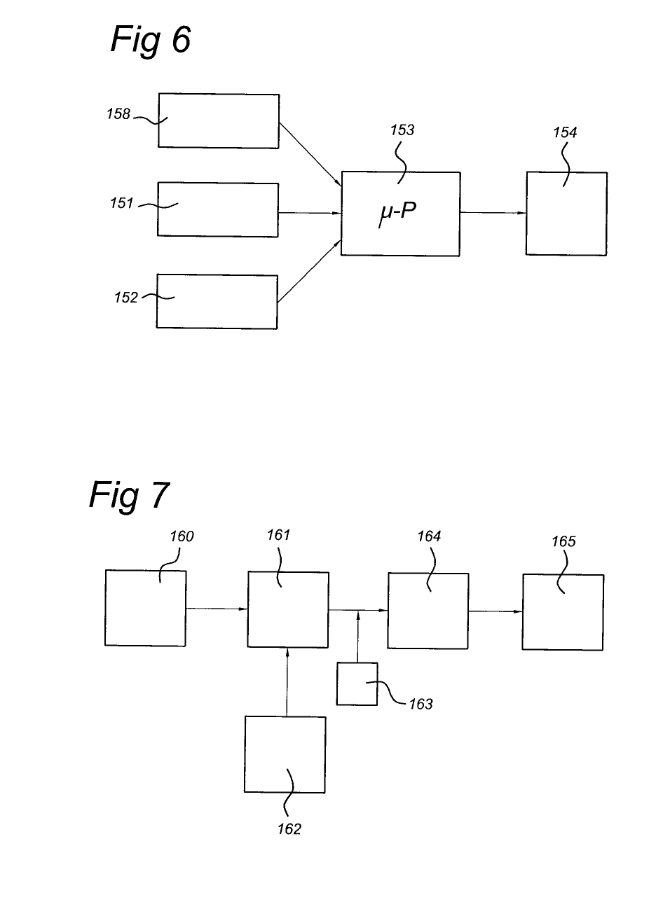

The lithographic apparatus operator can provide the process stack data to the memory of the lithographic apparatus. The correction height data may be specified in a number of ways. In an embodiment the calculation of the correction height data or field offset map according to an embodiment of the invention is performed on a separate computer including a processor 153 and several memories 150, 151, 152, as illustrated in FIG. 6. This allows the calculation of the specified correction data at a location separate from the lithographic apparatus and the correction data may be predetermined in this case. Providing a separate system for calculation of the field offset map may allow that such a system can be provided on a computer having a specialized processor 153 arranged and constructed for performing heavy duty calculations such as the calculation according to an embodiment of the invention. It is further possible to provide the important know how relating to the topology of the substrate and steps of building the layer stack to a computer separate from the lithographic apparatus for safety and/or security reasons. Alternately, the specified correction heights may be calculated on the fly, either locally or remote from the lithographic apparatus itself and the term “predetermined” need not imply a time ordering of the described steps.

Such a system according to an embodiment of the invention is provided with instructions from memories 150, 151, 152, which may be one and the same memory. The information may be loaded in the memories from one or more readable medium such as data carriers. The data carrier can include instructions arranged and constructed to perform the methods of the invention.

A memory 150 may contain instructions relating to a model for calculating the height reading error. The model includes an algorithm for calculating the level dependency.

In a memory 151 instructions relating to the process stack may be available, provided by the operator of the lithographic apparatus. In a third memory 152 instructions may be available relating to a material property such as reflectivity, absorption and polarization. The third memory 152 can also contain instructions relating to level sensor parameters such as used wavelength for the radiation, incident angle, etc. The memories 150 and 152 can be preprogrammed memories. Memory 151 can be a memory accessible for the operator.

The memories 150-152 are connected to a microprocessor 153 for calculation of the field offset map in accordance to an embodiment of the invention using the data available from the memories, for example using the model as provided in memory 150.

Although specific reference may have been made above to the use of embodiments of the invention in the context of optical lithography, it will be appreciated that the invention may be used in other applications, for example imprint lithography, and where the context allows, is not limited to optical lithography. In imprint lithography, a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

In the present document, the terms “radiation” and “beam” are used to encompass all types of electromagnetic radiation or particle flux, including, but not limited to, ultraviolet radiation (e.g., having a wavelength of or about 365 nm, 355 nm, 248 nm, 193 nm, 157 nm or 126 nm), extreme ultraviolet radiation (EUV), X-rays, electrons and ions. Also herein, the invention is described using a reference system of orthogonal X, Y and Z directions and rotation about an axis parallel to the I direction is denoted Ri. Further, unless the context otherwise requires, the term “vertical” (Z) used herein is intended to refer to the direction normal to the substrate or mask surface, rather than implying any particular orientation of the apparatus. Similarly, the term “horizontal” refers to a direction parallel to the substrate or mask surface, and thus normal to the “vertical” direction.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below. It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1-19. (canceled)

20. A method for positioning at least one target portion of a substrate with respect to a focal plane of a projection system, the method comprising:
performing height measurements of at least part of the substrate to generate height data;
using specified correction heights to compute corrected height data; and
positioning the target portion of the substrate with respect to the focal plane of the projection system at least partially based on the corrected height data,
wherein the method further comprises inputting process stack data and wherein the specified correction heights are calculated correction heights at least partially based on the process stack data.

21. A method according to claim 20, wherein calculating the specified correction heights comprises:
defining a grid having grid portions;
calculating a level sensor height reading error for each grid portion; and
averaging the calculated reading errors of each grid portion over the target area.

22. A method according to claim 20, wherein the process stack data comprises data relating to thicknesses of the at least top three layers of the substrate surface.

23. A method according to claim 20, wherein calculating the level sensor reading error comprises calculating the difference of the apparent height of a layer stack on a substrate and the actual top layer based on the process stack data.

24. A method according to claim 20, wherein the method further comprises calculating a height profile by averaging the corrected height data from different parts of the substrate.

25. A method of manufacturing a device using a lithographic projection apparatus comprising: a radiation system for supplying a projection beam of radiation; a first object table provided with a mask holder for holding a mask; a second object table provided with a substrate holder for holding a substrate; a level sensor for measuring at least one of the vertical position and tilt about at least one horizontal axis of an object held by one of said object holders and generating a position signal; and a servo system responsive to said position signal for moving said object to a desired position, the method comprising the steps of providing a mask bearing a pattern to said first object table, the method comprising:
providing a substrate having a radiation-sensitive layer to said second object table; and
imaging said irradiated portions of the mask onto said target portions of the substrate by operating said servo system to maintain said object at said desired position, wherein the desired position is at least partially dependent on correction height data calculated at least partially based on process stack data.

26. A method according to claim 25, wherein calculating the correction height data comprises:
defining a grid having grid portions;
calculating level sensor height reading errors for each grid portion; and
averaging the calculated difference of each grid portion over the target area.

27. A method according to claim 25, wherein calculating the level sensor height reading errors comprises calculating the difference of the apparent height of a layer stack in a height measurement and the actual top layer, said calculation being partially based on the process stack data.

28. A lithographic projection apparatus comprising:
a support constructed to support a patterning device, the patterning device being capable of imparting a radiation beam with a pattern in its cross-section to form a patterned radiation beam;
a substrate table arranged and constructed to hold a substrate;
a projection system constructed and arranged to project the patterned radiation beam onto a target portion of the substrate;
a level sensor constructed and arranged to perform height measurements of at least part of the substrate to generate height data, for use in positioning a target portion of the substrate with respect to a focal plane of the projection system;
an actuator for positioning the substrate table with respect to the projection system;
a controller constructed and arranged to control the actuator to position the target portion of the substrate in the focal plane of the projection system in accordance to corrected height measurements, wherein the controller comprises a processor for correcting the height measurements with predetermined correction heights from memory, wherein the memory contains correction heights based at least partially on process stack data.

29. A lithographic projection apparatus according to claim 28, wherein the memory contains instructions relating to the process stack data and wherein the processor is arranged and constructed to calculate the predetermined correction heights at least partially based on the process stack data in the memory.

30. A lithographic projection apparatus according to claim 29, wherein the memory further contains instructions relating to the reflective properties of substrate materials, and wherein the processor is arranged and constructed to calculate the predetermined correction heights at least partially based on the reflective properties of substrate materials in the memory.

31. A system for controlling the position of a substrate, the system comprising a processor and a memory, the memory being encoded with a computer program containing instructions that are executable by the processor to perform, using height data, a method for positioning a target portion of the substrate with respect to a focal plane of a projection system, wherein the method comprises:
performing height measurements of at least part of the substrate to generate the height data;
using predetermined correction heights to compute corrected height data for the height data; and
positioning the target portion of the substrate with respect to the focal plane of the projection system at least partially based on the corrected height data, wherein the predetermined correction heights are calculated at least partially based on process stack data.

32. A system according to claim 31, wherein the system is adapted to process height measurements from a level sensor.

33. A system according to claim 31, wherein the processor is adapted to communicate at least indirectly with a position sensor and is adapted to control at least indirectly the position the substrate.

34. A system according to claim 31, wherein the memory contains process stack data and the processor is arranged and constructed to calculate the correction heights at least partially based on the process stack data obtained from the memory.

35. A computer-readable storage medium having instructions stored thereon that are executable by a processor to perform, using height data, a method for positioning a target portion of a substrate with respect to a focal plane of a projection system, wherein the method comprises:
performing height measurements of at least part of the substrate to generate the height data;
using predetermined correction heights to compute corrected height data for the height data; and
positioning the target portion of the substrate with respect to the focal plane of the projection system at least partially based on the corrected height data, wherein the predetermined correction heights are calculated at least partially based on process stack data.

36. A computer-readable medium according to claim 35, wherein the instructions further cause the processor to execute steps for calculating the predetermined correction heights using process stack data from a memory.

37. A computer-readable medium according to claim 36, wherein the instructions comprise a table of reflective properties of substrate materials.

38. A method for positioning at least one target portion of a substrate with respect to a focal plane of a projection system, the method comprising:
performing height measurements of at least part of the substrate to generate height data;
using predetermined correction heights to compute corrected height data; and
positioning the target portion of the substrate with respect to the focal plane of the projection system at least partially based on the corrected height data,
wherein the method further comprises inputting process stack data and wherein the predetermined correction heights are calculated correction heights at least partially based on the process stack data.
